(19) United States
(12) Patent Application Publication
(10) Pub. No.: US 2025/0372667 A1
(43) Pub. Date: Dec. 4, 2025

(54) ELECTRODE CATALYST LAYER FOR FUEL CELL AND MANUFACTURING METHOD FOR ELECTRODE CATALYST LAYER FOR FUEL CELL

(71) Applicant: TOYOTA JIDOSHA KABUSHIKI KAISHA, Toyota-shi (JP)

(72) Inventor: Atsushi HIRAIDE, Suntou-gun (JP)

(73) Assignee: TOYOTA JIDOSHA KABUSHIKI KAISHA, Toyota-shi (JP)

(21) Appl. No.: 19/196,356

(22) Filed: May 1, 2025

(30) Foreign Application Priority Data
May 30, 2024 (JP) 2024-087864

(51) Int. Cl. H01M 4/92; H01M 4/86; H01M 4/88; H01M 8/1004

(52) U.S. Cl. CPC H01M 4/926; H01M 4/8605; H01M 4/8657; H01M 4/8828; H01M 8/1004

(57) ABSTRACT

An electrode catalyst layer for a fuel cell, including: a catalyst supporting material having a catalyst support, and a catalyst metal supported on the catalyst support; and an ionomer partially covering the catalyst supporting material. An ionomer coverage is not less than 25% and not more than 50%, the ionomer coverage being a ratio of a surface area covered by the ionomer relative to a surface area of the catalyst support obtained by three-dimensional transmission electron microscopy.

### CROSS-REFERENCE TO RELATED APPLICATION

This application claims priority to Japanese Patent Application No. 2024-087864 filed on May 30, 2024, incorporated herein by reference in its entirety.

### BACKGROUND

### 1. Technical Field

The present disclosure relates to an electrode catalyst layer for a fuel cell, a manufacturing method for an electrode catalyst layer for a fuel cell, and the like.

### 2. Description of Related Art

For example, a polymer electrolyte fuel cell has an electrode catalyst layer including a catalyst supporting material in which a catalyst metal such as Pt is supported on a conductive support. It is known as for the electrode catalyst layer to form, by covering the catalyst support with more ionomer, a three-phase interface of the catalyst metal, the proton-conductive ionomer, and reaction gas and to improve battery performance.

Meanwhile, on the electrode catalyst layer, gas diffusion resistance toward the catalyst metal occasionally increases due to the ionomer covering the surface of the catalyst metal supported on the support. In order to prevent the catalyst metal from being covered with the ionomer, it is proposed to retain the catalyst metal in mesopores of the catalyst support (WO 2016/067878). In WO 2016/067878, it is proposed to set a ratio of a specific surface area of the catalyst metal that gas can reach without passing through the electrolyte relative to the total specific surface area of the catalyst metal, in other words, a catalyst metal exposure ratio, to be not less than 50%, thereby reducing the gas diffusion resistance.

### SUMMARY

However, the method in WO 2016/067878 occasionally causes openings of the mesopores on the support particles to be covered with the ionomer. In such a case, gas needs to diffuse the ionomer to reach the catalyst metal. Accordingly, even in the method of WO 2016/067878, there is still a problem of the gas diffusion resistance due to the ionomer. Moreover, in the method of WO 2016/067878, use of a solid catalyst support is not considered.

The present specification provides a technology of making, as to an electrode catalyst layer for a fuel cell, the proton conductivity and the gas diffusion resistance compatible with each other by controlling a covering structure with the ionomer on the catalyst support surface.

The inventors have found that the gas diffusion and the proton conductivity can be made compatible with each other by setting an ionomer coverage to be in a predetermined range, the ionomer coverage being a ratio of a surface area covered by the ionomer relative to a surface area of the catalyst support measured by three-dimensional transmission electron microscopy (3D-TEM). Namely, an ionomer coverage that is with respect to the “catalyst” has been conventionally used as an index. Nonetheless, the inventors have employed an “ionomer coverage with respect to the catalyst support” rather than an “ionomer coverage with respect to the catalyst”. Furthermore, the knowledge has been obtained that restricting the “ionomer coverage with respect to the catalyst support” can improve the gas diffusivity while the proton conductivity is kept, to improve catalytic activity. It has been found that the “ionomer coverage with respect to the catalyst support” is a more effective index for improving the catalytic activity as to the ionomer.

A technology disclosed in the present specification is embodied as an electrode catalyst layer for a fuel cell. An electrode catalyst layer according to a first aspect of the present disclosure includes: a catalyst supporting material having a carbon-based catalyst support, and a catalyst metal supported on the catalyst support; and an ionomer partially covering the catalyst supporting material. Furthermore, an ionomer coverage is not less than 25% and not more than 50%, the ionomer coverage being a ratio of a surface area covered by the ionomer relative to a surface area of the catalyst support obtained by 3D-TEM.

According to the electrode catalyst layer, the catalyst support surface is partially covered in a predetermined ratio by the ionomer. Thereby, the proton conductivity due to contact between the catalyst metal and the ionomer is kept. Moreover, a region in which gas can reach the catalyst metal without passing through the ionomer regardless of a structure (porous/solid) of the catalyst support is secured on the catalyst support, and the gas diffusion resistance with respect to the catalyst metal is reduced. As a result, the electrode catalyst layer shows excellent catalytic activity, which contributes to excellent battery performance.

In the electrode catalyst layer according to the first aspect of the present disclosure, an average thickness of the ionomer may be not less than 6 nm and not more than 20 nm.

In the electrode catalyst layer according to the first aspect of the present disclosure, the ionomer may include a sulfonic acid-based ionomer.

In the electrode catalyst layer according to the first aspect of the present disclosure, the catalyst support may be porous particles or solid particles.

A membrane electrode assembly for a fuel cell according to a second aspect of the present disclosure may include the electrode catalyst layer according to the first aspect.

A fuel cell according to a third aspect of the present disclosure may include the membrane electrode assembly for a fuel cell according to the second aspect.

The technology disclosed in the present specification is also embodied as a manufacturing method for an electrode catalyst layer for a fuel cell. A manufacturing method according to a fourth aspect of the present disclosure includes: a step of preparing a catalyst ink including a catalyst supporting material having a carbon-based catalyst support, and a catalyst metal supported on the catalyst support, an ionomer, and an aqueous medium including water, a bipolar solvent having a boiling point exceeding 100° C. and not more than 170° C., and ethanol; and a step of feeding the catalyst ink onto a base substrate and drying to form the electrode catalyst layer.

According to the manufacturing method, by adjusting the ionomer coverage measured by 3D-TEM, the electrode catalyst layer including the catalyst supporting material having the ionomer coverage not less than 25% and not more than 50% is obtained. This electrode catalyst layer shows excellent catalytic activity, which contributes to excellent battery performance.

In the manufacturing method according to the fourth aspect of the present disclosure, the bipolar solvent may include diacetone alcohol.

In the manufacturing method according to the fourth aspect of the present disclosure, a mass ratio of the ethanol relative to the bipolar solvent may be not less than 0.10 and not more than 0.50.

In the manufacturing method according to the fourth aspect of the present disclosure, the mass ratio of the ethanol relative to the bipolar solvent may be not less than 0.13 and not more than 0.42.

### BRIEF DESCRIPTION OF THE DRAWINGS

Features, advantages, and technical and industrial significance of exemplary embodiments will be described below with reference to the accompanying drawings, in which like signs denote like elements, and wherein:

FIG. 1 is a sectional view showing a basic configuration of a polymer electrolyte fuel cell according to an embodiment of the present disclosure;

FIG. 2A is a sectional view showing an example of a catalyst supporting particle which is a catalyst supporting material according to an embodiment of the present disclosure;

FIG. 2B is a sectional view showing an example of the catalyst supporting particle which is the catalyst supporting material according to an embodiment of the present disclosure;

FIG. 3 is a diagram showing relationship between a mass ratio of ethanol relative diacetone alcohol in a catalyst ink and an ionomer coverage;

FIG. 4 is a diagram showing relationship between the ionomer coverage and a gas diffusion resistance;

FIG. 5 is a diagram showing relationship between the ionomer coverage and a catalyst layer proton resistance;

FIG. 6 is a diagram showing relationship in power generation performance between Examples and Comparative Examples;

FIG. 7 is a diagram showing relationship in power generation performance (target output value) between Examples and Comparative Examples; and

FIG. 8 is a diagram showing relationship between the ionomer coverage and the power generation performance (target output value).

### DETAILED DESCRIPTION OF EMBODIMENTS

An electrode catalyst layer for a fuel cell disclosed in the present specification (in the present specification, hereinafter also referred to as a catalyst layer) includes: a catalyst supporting material having a carbon-based catalyst support and a catalyst metal supported on the catalyst support; and an ionomer partially covering the catalyst supporting material. An ionomer coverage is not less than 25% and not more than 50%, the ionomer coverage being a ratio of a surface area covered by the ionomer relative to a surface area of the catalyst support measured by 3D-TEM.

In another embodiment of the aforementioned catalyst layer, the average thickness of the ionomer is not less than 6 nm and not more than 20 nm. When the average thickness is in this range, the catalyst support is covered by a sufficient amount of ionomer.

In another embodiment of the aforementioned catalyst layer, the ionomer includes a sulfonic acid-based ionomer. This is because the sulfone-based ionomer is occasionally advantageous to restriction of the ionomer coverage and improvement of power generation performance.

In another embodiment of the aforementioned catalyst layer, the catalyst support includes porous particles or solid particles. Using these particles occasionally makes control of the ionomer coverage easy.

A membrane electrode assembly for a fuel cell disclosed in the present specification includes the aforementioned electrode catalyst layer and an electrolyte layer. A fuel cell disclosed in the present specification includes the membrane electrode assembly for a fuel cell.

The membrane electrode assembly for a fuel cell, and the fuel cell disclosed in the present specification can include various aspects of the aforementioned catalyst layer.

In a manufacturing method for an electrode catalyst layer for a fuel cell disclosed in the present specification, the bipolar solvent may include diacetone alcohol. Diacetone alcohol may be occasionally employed for adjusting the ionomer coverage. Furthermore, in an embodiment of the manufacturing method, a mass ratio of ethanol relative to the bipolar solvent is not less than 0.10 and not more than 0.50. This is because the mass ratio being in this range makes it easy to adjust the ionomer coverage.

Hereafter, the electrode catalyst layer for a fuel cell, the manufacturing method for the electrode catalyst layer, the membrane electrode assembly (MEA) for a fuel cell, the fuel cell, and the like disclosed in the present specification will be described properly with reference to the drawings. Notably, for convenience of description, the summary of a fuel cell is described, and afterward, the disclosure in the present specification is described. Notably, not being specially limited, the fuel cell in the present specification is, for example, a polymer electrolyte fuel cell (PEFC). Otherwise, the fuel cell may be a fuel cell for being mounted on a movable body such as an FCEV or be a stationary fuel cell.

### Fuel Cell

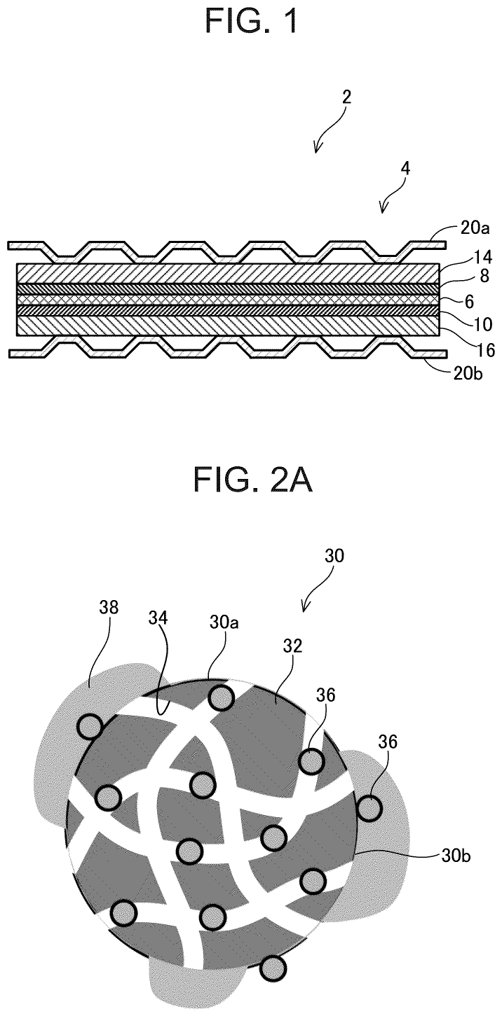

Not being specially limited, a fuel cell 2 is typically configured by a plurality of cells 4 being stacked or wound. FIG. 1 shows an example of the fuel cell 2 in which the cells 4 are stacked. The cell 4 includes an electrolyte layer 6, an anode electrode catalyst layer (hereinafter also referred to as an anode catalyst layer) 8 and a cathode electrode catalyst layer (hereinafter also referred to as a cathode catalyst layer) 10 that the electrolyte layer 6 is interposed and held between, an anode gas diffusion layer 14, a cathode gas diffusion layer 16, and a pair of separators 20a, 20b. The electrolyte layer 6, the anode catalyst layer 8, and the cathode catalyst layer 10 form a membrane electrode assembly (MEA). They may form a membrane electrode gas diffusion layer assembly (MEGA) by the anode gas diffusion layer 14 and the cathode gas diffusion layer 16 being further joined.

### Electrolyte Layer

For example, a fluorine-based ionomer or a hydrocarbon-based ionomer described as an ionomer (polymer electrolyte) mentioned later can be used. In this case, identical one to ionomers that are used for the catalyst layers 8, 10 is not necessarily used.

A thickness of the electrolyte layer 6 may be properly determined in consideration of characteristics of the fuel cell 2 to be obtained, not being specially limited. The thickness of the electrolyte layer is typically about 5 μm to 300 μm. Those of the anode catalyst layer 8 and the cathode catalyst layer 10 are mentioned later.

### Gas Diffusion Layer

Not being specially limited, known materials can be properly used for the anode gas diffusion layer 14 and the cathode gas diffusion layer 16. A thickness of a base material may be properly determined in consideration of characteristics of each gas diffusion layer 14, 16 obtained, being about 30 μm to 500 μm.

Separator The pair of separators 20a, 20b are an anode separator 20a and a cathode separator 20b, interpose and hold the anode gas diffusion layer 14 and the cathode gas diffusion layer 16, respectively, from the outside. On each of the separators 20a, 20b, gas flow paths may be formed in a gap toward the gas diffusion layer by molding a plate material into a corrugated form, the plate material being of carbon such as carbon graphite or a carbon plate, a metal material such as stainless steel, or the like. Notably, in FIG. 1, gas seal parts and the like between the separators 20a, 20b and the electrolyte layer 6 are omitted. Notably, a lateral surface side, of each separator 20a, 20b, that does not face the gas diffusion layer 14, 16 forms flow paths for a coolant such as water during operation of the fuel cell 2.

### Catalyst Layer

Each of the anode catalyst layer 8 and the cathode catalyst layer 10 includes a carbon-based catalyst support 32, a catalyst metal 36 supported on the catalyst support 32, and an ionomer 38 partially covering the catalyst support 32. A catalyst layer in the present specification may be any of the anode catalyst layer 8 and the cathode catalyst layer 10. The cathode catalyst layer 10 may be occasionally employed in view of gas diffusivity and the like. While the catalyst support 32 can take various shapes as mentioned later, there are hereafter exemplarily described catalyst supporting particles 30 as a catalyst supporting material in which the catalyst support 32 is in a form of particles. Moreover, the anode catalyst layer 8 and the cathode catalyst layer 10 are collectively referred to as catalyst layers 12 in the description below.

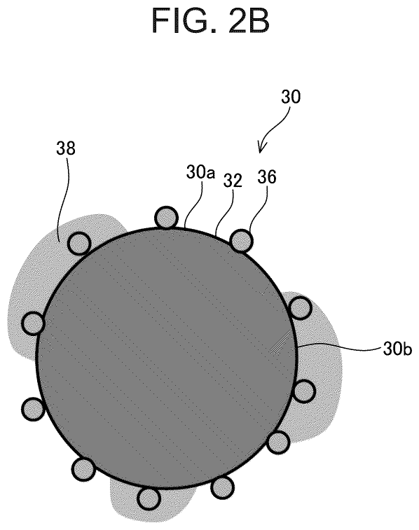

FIG. 2 shows a summary of the catalyst supporting particle 30. As shown in FIG. 2, the catalyst supporting particle 30 has the carbon-based catalyst support 32, the catalyst metal 36, and the ionomer 38. Materials and the like of these are mentioned later, and a covering structure of the ionomer 38 on the catalyst supporting particle 30 constituted of these is hereafter described.

In the catalyst layer 12 shown in FIG. 2, the catalyst support 32 is in a particle shape. The catalyst support 32 may be a porous particle or may be a solid particle. FIG. 2A shows an example of the porous particle of the catalyst support 32, and FIG. 2B shows an example of the solid particle.

As shown in FIG. 2A, the catalyst support 32 includes the catalyst metal 36 on its surface, and in the case where the catalyst support 32 is the porous particle, includes the catalyst metal 36 inside pores 34. As shown in FIG. 2B, in the case of being the solid particle, the catalyst support 32 includes the catalyst metal 36 only on its surface.

As shown in FIG. 2A and FIG. 2B, the ionomer 38 partially covers a surface of the catalyst supporting particle 30. Thereby, the catalyst supporting particle 30 includes a surface 30a that is not covered by the ionomer 38 and the catalyst support 32 is exposed from, and a surface 30b that is covered by the ionomer. Including the surface 30a allows gas fed from the outside to be in direct contact or direct contact via the pores 34 with the catalyst metal 36.

The ionomer 38 covers the surface of the catalyst support 32 such that an ionomer coverage is not less than 25% and not more than 50%, the ionomer coverage being a ratio of a surface area covered by the ionomer 38 relative to a surface area of the catalyst support 32 measured by 3D-TEM. In this range, there can be provided the catalyst layer 12 in which gas diffusion resistance and proton conductivity are compatible with each other and that can contribute to excellent power generation performance. Such a range of the ionomer coverage is a range that gives a larger exposed amount of the surface of the catalyst support 32 than that of this type of conventional catalyst support 32.

Here, the 3D-TEM is a technique of analyzing a three-dimensional structure of a material by using computerized tomography (CT) on TEM projection images obtained by image capturing while the target object is being consecutively inclined using TEM. This technique is a technique that can three-dimensionally observe a steric structure (state of dispersion, defects, and the like) of a material to make quantitative evaluations through image analysis, such as a particle size, a particle size distribution, a volume, a surface area, and a thickness. Therefore, by observing the catalyst layer 12 including the catalyst supporting particles 30 using the 3D-TEM, a surface area and a surface structure (for specifying non-coverage regions and coverage regions with the ionomer) of the catalyst support 32, a surface area that is covered by the ionomer 38, and a thickness of the ionomer 38 can be measured.

For this 3D-TEM, known 3D-TEM can be properly used, and those skilled in the art can obtain the ionomer coverage in the catalyst layer 12 using the known 3D-TEM and a measurement program included in the 3D-TEM. Samples for the 3D-TEM are not specially limited, and may include the catalyst layer 12 itself, and the catalyst layer 12 that is in the state of a MEA or a MEGA. For example, the catalyst layer 12 may be one obtained by application and drying of a catalyst ink or may be one obtained by further thermocompression. The sample may be obtained by sampling a predetermined size by scratching a part of the surface of one formed as the catalyst layer 12. Details of preparation of a test powder from the sample are disclosed in Examples. Notably, when the ionomer coverage is measured, there is employed, as the ionomer coverage of a test powder, the result of measurement of one target region (200 nm×200 nm) under setting the target region on the test powder obtained from the catalyst layer 12 as a measurement target.

According to the 3D-TEM, the ionomer coverage is obtained, for example, by the following technique. Calculation is performed as a ratio (%) of the surface area of the surface 30b that is evaluated to be covered by the ionomer 38 relative to the surface area of the catalyst support 32 (for example, the total surface area of the surface area of the surface 30a that is evaluated where the catalyst support 32 is exposed by the 3D-TEM and the surface 30b that is evaluated to be covered by the ionomer 38).

This is because when the ionomer coverage is less than 25%, a proton resistance of the catalyst layer 12 measured by an AC impedance method tends to exceed 1.5 ΩQ/cm². According to the inventors, unless the proton resistance is not more than 1.5 ΩQ/cm², the intended power generation performance cannot be obtained. For example, in view of the proton resistance, the ionomer coverage may occasionally be not less than 30% or not less than 35%.

Moreover, this is because when the ionomer coverage exceeds 50%, a gas diffusion resistance measured by a limiting current density method tends to exceed 23.5 s/m.

According to the inventors, unless the gas diffusion resistance is not more than 23.5 s/m, the intended power generation performance cannot be obtained. For example, in view of the gas diffusion resistance, the ionomer coverage may occasionally be not more than 48%, not more than 45%, not more than 40%, or not more than 38%.

In addition to being not less than 25% and not more than 50%, the range of the ionomer coverage can be set by properly combining the lower limits and the upper limits mentioned above, for example, being able to be not less than 30% and not more than 40%.

On the surface 30b covered by the ionomer 38 as to the catalyst supporting particle 30, a layer of the ionomer 38 is formed. A thickness of the layer of the ionomer 38 may be, as an average thickness measured by the 3D-TEM, not less than 6 nm and not more than 20 nm. When the average thickness is in this range, the catalyst support 32 is covered by a sufficient amount of ionomer 38. Moreover, such an average thickness range is effective for securing an appropriate mass ratio between the catalyst metal 36 and the ionomer 38 to secure proton conductivity. Such an average thickness may occasionally be, for example, not less than 7 nm, not less than 8 nm, not less than 9 nm, or not less than 10 nm. Moreover, it may occasionally be, for example, not more than 18 nm, not more than 16 nm, not more than 14 nm, not more than 12 nm, or not more than 10 nm.

For a sample in the case where the average thickness of the ionomer 38 is measured, the similar sample to that in the case where the ionomer coverage is measured can be used. Notably, when the average thickness of the ionomer 38 is measured, there is employed, as the average thickness of the ionomer of a test powder, a median value (value at 50% of cumulative frequency) in a volume-based cumulative frequency distribution of thicknesses of the ionomer 38 measured in one target region (200 nm×200 nm) under setting the target region on the test powder obtained from the catalyst layer 12 as a measurement target.

Not being specially limited, for a material of the catalyst support 32, a known porous or non-porous (solid) carbon-based support material can be properly selected and used. A shape of the catalyst support 32 may employ particles in various forms, or otherwise, a continuous body. As the particles, particles in various forms, such as spherical ones, fibrous ones, and amorphous ones, can be used. Moreover, examples of the continuous body include interlaced bodies such as a knitted body, a net-like body, a cloth-like body, and nonwoven fabric. In the case of the porous material, the form, the pore size, and the like are also not specially limited.

Not being specially limited, examples of the material of the catalyst support 32 include carbon materials composed of carbon black (Ketjen black, oil furnace black, channel black, lamp black, thermal black, acetylene black, and the like), activated carbon, and the like. Moreover, the examples include carbon fibers such as multiwall carbon nanotubes. Such carbon fibers can take various forms such as nonwoven fabric, carbon paper, and carbon cloth.

Moreover, in addition to the above, the catalyst support 32 may include porous metal such as Sn (tin) and Ti (titanium), and furthermore, conductive metal oxide and the like, as a part of the support. A size and a form of the pores 34 included in the catalyst support 32 are also not specially limited.

The catalyst metal 36 has a function of catalytic action of an electrochemical reaction. Here, the catalyst metal used for the anode catalyst layer 8 is not specially limited as long as it has catalytic action on an oxidation reaction of hydrogen, and a known catalyst can be similarly used.

The catalyst metal 36 used for the cathode catalyst layer 10 is also not specially limited as long as it has catalytic action on a reduction reaction of oxygen, and a known catalyst can be similarly used. Specifically, the selection can be performed from metals such as platinum, ruthenium, iridium, rhodium, palladium, osmium, tungsten, lead, iron, copper, silver, chromium, cobalt, nickel, manganese, vanadium, molybdenum, gallium, and aluminum, alloys of these, and the like. For example, in view of catalytic activity and the like, platinum or a platinum alloy of platinum with one or two kinds or more selected from the group consisting of ruthenium, iron, nickel, manganese, cobalt, and copper may occasionally be employed.

A shape and a size of the catalyst metal 36 are not specially limited, and the shape and the size similar to those of a known catalyst component can be employed. For the shape, for example, ones in a form of particles, a form of flakes, a lamellar form, and the like can be used, and one in a form of particles may be used. An average particle size of the catalyst metal is not specially limited.

The ionomer 38 has proton conductivity. Moreover, it also functions in the catalyst layer 12 as a binder for the catalyst support 32 and the like. Not being specially limited, the ionomer 38 can be used by one or two kinds or more being properly selected from various known materials.

The ionomers 38 are roughly categorized into fluorine-based ionomers and hydrocarbon-based ionomers, and a fluorine-based ionomer may be employed.

Examples of the fluorine-based ionomers include a perfluorocarbonsulfonic acid-based polymer, a perfluorocarbonsulfonic acid-based polymer, a trifluorostyrenesulfonic acid-based polymer, an ethylene tetrafluoroethylene-g-styrenesulfonic acid-based polymer, an ethylene-tetrafluoroethylene copolymer, and a polyvinylidene fluoride-perfluorocarbonsulfonic acid-based polymer. The perfluorocarbonsulfonic acid-based polymer may occasionally be employed. Such fluorine-based polymer electrolytes are used.

Examples of the hydrocarbon-based ionomers include sulfonated polyethersulfone (S-PES), sulfonated polyaryl ether ketone, sulfonated polybenzimidazole alkyl, phosphonated polybenzimidazole alkyl, sulfonated polystyrene, sulfonated polyether ether ketone (S-PEEK), and sulfonated polyphenylene (S-PPP).

In these ionomers, a proton acid group as a proton conductive group may be a sulfonic acid group, or may be a carbonic acid group, a phosphonic acid group, a boronic acid group, or the like.

The proton conductivity of the ionomer 38 is not specially limited, can be properly selected and employed, and, for example, can be properly selected and employed from ones in a range about not less than 600 g/mol and not more than 1500 g/mol.

In addition, the catalyst layer 12 may include, as needed, additives such as a water repellent such as polytetrafluoroethylene, polyhexafluoropropylene, or a tetrafluoroethylene-hexafluoropropylene copolymer, a dispersant such as a surfactant, a thickener such as glycerol, ethylene glycol (EG), polyvinyl alcohol (PVA), or propylene glycol (PG), and a pore forming agent.

A thickness of the catalyst layer 12 (dry film thickness) is not specially limited, and is about not less than 1 μm and not more than 50 μm. The thickness is applied to those of both the cathode catalyst layer 10 and the anode catalyst layer 8, and the thicknesses of these are equivalent or different.

According to the catalyst layer 12 described above, setting the ionomer coverage on the catalyst support 32 to be in the predetermined range can readily make proton conductivity and gas diffusivity compatible with each other to improve catalytic activity, and thereby, can contribute to improvement of power generation characteristics of the fuel cell.

### Manufacturing Method for Catalyst Layer

A manufacturing method for a catalyst layer disclosed in the present specification (hereinafter also referred to as the present manufacturing method) includes: a step of preparing a catalyst ink including a catalyst material having a carbon-based catalyst support, and a catalyst metal supported on the catalyst support, an ionomer, and an aqueous medium including water, a bipolar solvent having a boiling point exceeding 100° C. and not more than 170° C., and ethanol; and a step of feeding the catalyst ink onto a base substrate and drying to form the catalyst layer. According to this manufacturing method, by using the aqueous medium, the catalyst layer in which the ionomer coverage at which the surface of the catalyst support is covered is restricted can be obtained.

To the catalyst support, the catalyst metal, the ionomer, the catalyst layer, and the like in the present manufacturing method, there are applied various aspects of the catalyst support 32, the catalyst metal 36, the ionomer 38, and the catalyst layer 12 having been already described.

### Catalyst Ink Preparing Step

The step of preparing the catalyst ink is a step of preparing or obtaining a catalyst ink including the catalyst supporting material, the ionomer 38, and the aqueous medium including water, the bipolar solvent, and ethanol. For example, the catalyst ink can be obtained by adding water to the catalyst supporting material, afterward, adding the bipolar solvent and ethanol to make a suspension, further adding the ionomer, and afterward, performing dispersion processing with an ultrasonic homogenizer or the like. The catalyst ink can be obtained by further performing, as needed, stirring processing with a high shear force.

The catalyst supporting material can be obtained by a known method. Those skilled in the art have known a method of causing the catalyst support 32 to support the catalyst metal 36. Typically, the catalyst metal can be supported on the catalyst support 32 by known methods such as an impregnation method, a liquid phase reduction supporting method using acid such as citric acid, a method of evaporation to dryness, a colloid absorption method, an atomized pyrolysis method, and reversed micelle (microemulsion method).

Those skilled in the art have also known a method of mixing the catalyst supporting material, the ionomer 38, and the aqueous medium to prepare the catalyst ink. Here, the aqueous medium includes water, the bipolar solvent, and ethanol. The bipolar solvent is a solvent having a group contributing to H-donating ability of the solvent, such as a hydroxyl group, an amino group, and an amide group, and a group contributing to H-accepting ability of the solvent, such as an ether group and a ketone group. The hydroxyl group, the amino group, and the amide group are also groups contributing to the H-accepting ability simultaneously. Using the bipolar solvent makes the coverage of the ionomer 38 on the surface of the catalyst support 32 readily controlled.

Since the bipolar solvent has a boiling point higher than 100° C. and not higher than 170° C., which is higher than those of water (100° C.) and ethanol (78° C.) as the other solvents, mutual aggregation of the catalyst support 32 can be restrained while absorption between the catalyst support 32 and the ionomer 38 is restrained. As a result, the coverage of the ionomer 38 on the catalyst support 32 can be controlled. Namely, since the catalyst support 32 such as carbon and the ionomer 38 have hydrophobic sites, if a ratio of water in the solvent of the ink is high, hydrophobic interaction causes absorption between the catalyst support 32 such as carbon and the ionomer 38 and makes an aggregate. When the solvent includes water and ethanol, during heating in a drying step, the ethanol lower in boiling point evaporates earlier, which causes a state where the ratio of water is high. Accordingly, aggregation of the catalyst support 32 such as carbon and the ionomer 38 tends to occur. Herein, addition of the bipolar solvent such as a high boiling point alcohol solvent restrains increase in ratio of water in the solvent even when the ethanol evaporates during the heating. Therefore, aggregation of the catalyst support 32 and the ionomer 38 can be restrained, and the coverage of the ionomer 38 on the catalyst support 32 can be controlled. For example, the boiling point of the bipolar solvent is not less than 110° C., not less than 120° C., not less than 130° C., not less than 140°° C., or not less than 150° C.

Examples of such a high boiling point bipolar solvent include diacetone alcohol (166° C.), acetylacetone (141° C.), n-butyl alcohol (117° C.), cyclohexanol (162° C.), N,N-dimethylacetamide (165° C.), N,N-dimethylformamide (153° C.), 2-methoxyethanol (124° C.), 2-ethoxyethanol (135° C.), 1-hexanol (157° C.), isoamyl alcohol (131° C.), 1-pentanol (138° C.), and 3-pentanol (116° C.). One kind of the bipolar solvents can be solely used, or two kinds or more of those can be combined and used. Among those, diacetone alcohol may occasionally be employed in view of the polarity and the boiling point.

A mass ratio (ethanol/bipolar solvent) of the ethanol relative to the mass of the bipolar solvent in the aqueous medium is related to the ionomer coverage on the surface of the catalyst support 32. The mass ratio may be properly adjusted such that a preferable ionomer coverage is obtained. Not being specially limited, the mass ratio can be set to be not less than 0.10 and not more than 0.50, for example. As the mass ratio of the ethanol relative to the bipolar solvent is larger, an aggregate ratio of the ionomer 38 on the surface of the catalyst support 32 tends to decrease more, and the ionomer coverage tends to rise more. When the mass ratio is less than 0.10, the ionomer coverage tends to be less than 25%. Moreover, when the mass ratio exceeds 0.50, the ionomer coverage tends to exceed 50%. For example, the mass ratio is not less than 0.12, not less than 0.13, not less than 0.14, not less than 0.15, not less than 0.20, not less than 0.25, or not less than 0.30, and, for example, is not more than 0.48, not more than 0.46, not more than 0.44, not more than 0.42, or not more than 0.40.

Not being specially limited, a mass ratio of the water relative to the mass of the bipolar solvent in the aqueous medium can be set to be not less than 2.0 and not more than 4.0, for example. Moreover, it is not less than 2.1, or not less than 2.2, for example. Moreover, it is not more than 3.4, not more than 3.2, or not more than 3.0, for example.

Notably, not being specially limited, a mass ratio of the water relative to the total mass of the water, the bipolar solvent, and the ethanol in the aqueous medium is, for example, not less than 60 mass % and not more than 75 mass %, or, for example, not less than 65 mass % and not more than 70 mass %. Moreover, not being specially limited, a content of the bipolar solvent relative to the total mass is, for example, not less than 18 mass % and not more than 32 mass %. Moreover, it is, for example, not less than 20 mass %, not less than 22 mass %, not less than 24 mass %, or not less than 26 mass %. Moreover, it is, for example, not more than 30 mass %, or not more than 28 mass %. Not being specially limited, a content of the water relative to the total mass of the catalyst ink is, for example, not less than 50 mass % and not more than 70 mass %.

Notably, in addition to water, ethanol, and the bipolar solvent, the aqueous medium can include another solvent to such an extent that the ionomer coverage is satisfied. Examples of the other solvent include methanol, 1-propanol, 2-propanol, 1-butanol, 2-methyl-1-propanol, 2-butanol, and 2-methyl-2-propanol. Among these, an alcohol having a boiling point not less than 60° C. and not more than 100° C. may be used.

Not being specially limited, concentrations of the ionomer, the catalyst supporting material, and the like in the catalyst ink may be 1 mass % to 50 mass % in the catalyst ink, still being about 5 mass % to 30 mass %.

As to the catalyst ink, when, in addition to the components having been already described, additives such as a water repellent, a dispersant, a thickener, and a pore forming agent to such an extent that the coverage control with the ionomer is not disturbed, these additives are allowed to be added to the catalyst ink.

Notably, according to the present specification, such a catalyst ink is also provided.

### Step of Forming Catalyst Layer

The step of forming the catalyst layer 12 is a step of feeding the catalyst ink onto a base substrate and drying to form the catalyst layer 12. Here, for the base substrate, the electrolyte layer 6 or the gas diffusion layer 14, 16 can be used. Otherwise, as the base substrate, a peelable base material (sheet for transfer) such as a polytetrafluoroethylene (PTFE) sheet may be used to obtain the catalyst layer 12 by forming the catalyst layer 12 on such a base substrate, and afterward, peeling off the catalyst layer portion from the base substrate.

A method of feeding the catalyst ink onto the base substrate is not specially limited, and a known application method is properly selected. Examples of the method include a spraying method, a screen printing method, a doctor blade method, a gravure printing method, and a die coating method.

In the final stage, as to the catalyst ink on the base substrate, the applied layer (film) of the catalyst ink is dried under an air atmosphere or under an inactive gas atmosphere, for example, at room temperature to 180° C. for 1 minute to 60 minutes in consideration of the type of the solvents and the like. Thereby, the catalyst layer 12 is formed.

### Membrane Electrode Assembly

The membrane electrode assembly disclosed in the present specification can include the catalyst layer 12 having been already described. Namely, the membrane electrode assembly includes what is called an MEA that includes the electrolyte layer 6, the anode catalyst layer 8 arranged on one side of the electrolyte layer 6, and the cathode catalyst layer 10. Furthermore, the membrane electrode assembly includes what is called a MEGA that includes the anode gas diffusion layer 14 arranged with respect to the anode catalyst layer 8, and the cathode gas diffusion layer 16 arranged with respect to the cathode catalyst layer 10.

At least one of the anode catalyst layer 8 and the cathode catalyst layer 10 is the catalyst layer 12 that has the ionomer coverage in the predetermined range. In consideration of improvement of the proton conductivity and the diffusion characteristics of gas (in particular, O₂), the cathode catalyst layer 10 may be at least the aforementioned catalyst layer 12.

Moreover, the fuel cell 2 disclosed in the present specification includes the membrane electrode assembly that is the MEA or, for example, the MEGA mentioned above. The fuel cell 2 includes the cells 4 each further including the pair of separators 20a, 20b, in addition to the MEA and the gas diffusion layers 14, 16 or to the MEGA. The fuel cell may be a stacked structure body that has the cells as above stacked and includes current collector portions and manifolds.

### Manufacturing Method for Membrane Electrode Assembly and the Like

Not being specially limited, methods for producing the membrane electrode assembly and the fuel cell can employ conventionally know methods. For example, the anode catalyst layer 8 and the cathode catalyst layer 10 may be supplied to the electrolyte layer 6, dried and joined to form the MEA. Moreover, they may form the MEGA by further joining the gas diffusion layers 14, 16, and otherwise, they may be interposed, held and joined between the pair of separators 20a, 20b to form the fuel cell 2 that is a single cell 4. Pressurizing conditions and/or temperature conditions in joining of each of the catalyst layers 8, 10, the gas diffusion layers 14, 16, and the separators 20a, 20b are properly set as needed.

Otherwise, the fuel cell 2 may be formed by stacking the cells 4 and the like manufactured as above to form the stacked structure body. The conventionally known knowledge in the field of fuel cells can be properly referred to.

While Examples having the disclosure in the present specification embodied are hereafter exemplarily described, the disclosure in the present specification is not constrained to Examples below.

For each of the present examples, a catalyst ink was prepared to produce a MEA, afterward, using this MEA, a fuel cell for evaluation was produced, and for the MEA or the fuel cell, the ionomer coverage, the thickness of the ionomer, the gas diffusion resistance, the catalyst layer proton resistance, and power generation characteristics were evaluated. Methods for producing fuel cells and various evaluation methods are hereafter described.
(1) Preparation of Catalyst Ink

Catalyst supporting particles which form a catalyst supporting material having platinum-cobalt supported on carbon particles were prepared. To the catalyst supporting particles, distilled water was added, and afterward, diacetone alcohol and ethanol were added and dispersed. In this stage, the addition was performed so as to attain a mass ratio of ethanol/diacetone alcohol and a mass ratio of distilled water relative to diacetone alcohol presented in Table 1. Furthermore, an ionomer having a sulfonic acid group was added, sufficient dispersing processing was performed using an ultrasonic homogenizer, furthermore, a high shear force was applied using a rotary stirring apparatus (FILMIX, PRIMIX Corporation) to prepare four kinds of catalyst inks for a cathode. Notably, for all the catalyst inks, the amounts of the distilled water, the amounts of the catalyst supporting particles, and the amounts of the ionomer were made equal. Moreover, the amount of the distilled water was 60 mass % of the total mass of the catalyst ink.

TABLE 1

| | Mass Ratio | Mass Ratio | | Average |
|---|---|---|---|---|
| | of | of Distilled | | Thick- |
| | Ethanol | Water | | ness |
| | Relative to | Relative to | Ionomer | of |
| | Diacetone | Diacetone | Coverage | Ionomer |
| | Alcohol | Alcohol | % | nm |
| Example 1 | 0.13 | 2.4 | 32 | 8 |
| Example 2 | 0.42 | 3.0 | 36 | NT |
| Comparative Example 1 | 1.84 | 6.0 | 65 | NT |
| Comparative Example 2 | 4.67 | 12.0 | 85 | 5 |

(2) Production of MEA

Common to fuel cells of Examples and Comparative Examples, a MEA was produced by forming a cathode catalyst layer and an anode catalyst layer on both surfaces of an electrolyte membrane. Namely, using a die coater directly on the electrolyte membrane, the catalyst ink for an anode was applied to have a predetermined film thickness and dried to form the anode catalyst layer. Moreover, for the cathode catalyst layer, the catalyst ink for a cathode was applied on a surface of a film base material of PTFE using an applicator-type coating machine and dried at 80° C. for five minutes to form a film, and this film was transferred to the electrolyte membrane thereby to form the cathode catalyst layer.
(3) Production of Fuel Cell

Carbon cloths functioning as gas diffusion layers were pasted on both sides of the MEA of each of Examples and Comparative Examples produced in (2) to produce the fuel cell.
(4) Evaluation Methods

### Ionomer Coverage

Powder scratched from the surface of the cathode catalyst layer of each of the MEAs of Examples and Comparative Examples was well mixed and homogenized to be used as a test powder to perform 3D-TEM observation. Notably, in the 3D-TEM, one evaluation target region of 200 nm×200 nm was selected from the field of observation of this test powder. On the selected region, the ionomer coverage which is the ratio of the surface area covered by the ionomer relative to the surface area of the catalyst support material was calculated. Table 1 also presents the results.

### Thickness of Ionomer

A test powder was prepared by the similar method to that for the evaluation of the ionomer coverage, and on the test powder, one evaluation target region of 200 nm×200 nm was selected. On the selected region, a volume-based cumulative frequency distribution of thicknesses of the ionomer covering the catalyst support material was created. The median value was obtained, and this median value (50% of cumulative frequency) was set to the average thickness of the ionomer in the test powder. Table 1 also presents the results.

### Gas Diffusion Resistance, Catalyst Layer Proton Resistance, Power Generation Characteristics, and the Like

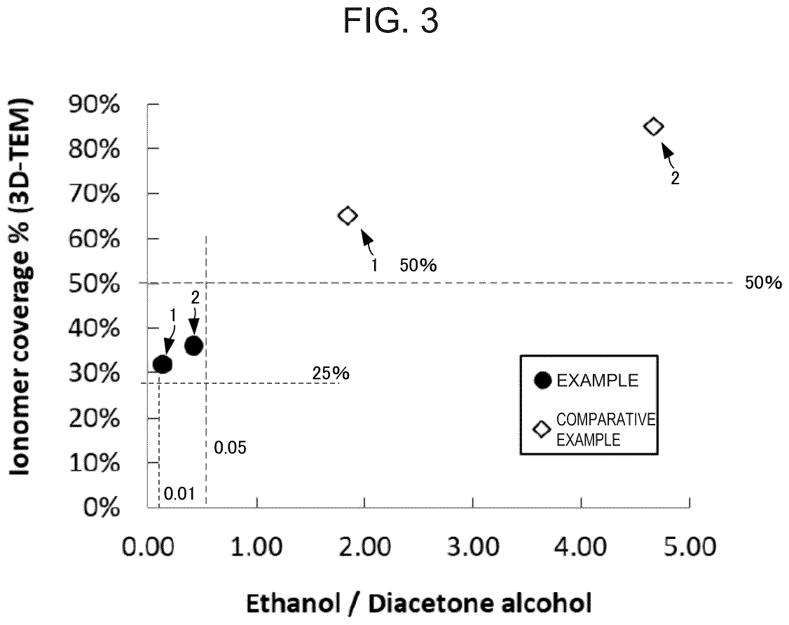

The gas diffusion resistance (limiting current density method), the catalyst layer proton resistance (AC impedance method), and the power generation characteristics were measured by the corresponding measurement devices, and the power generation characteristics (output) were evaluated using a fuel cell evaluation system produced by TOYO Corporation (“TOYO Tekunika”). FIG. 3 to FIG. 8 show the evaluation results.

### Results

1: Relationship Between Mass Ratio of Ethanol Relative to Diacetone Alcohol in Aqueous Medium, Ionomer Coverage, and Average Thickness of Ionomer

As presented in Table 1, the ionomer coverages in the cathode catalyst layers of the MEAs of Examples 1 and 2 were 32% and 36%, and the ionomer coverages of Comparative Examples 1 and 2 were 65% and 85%. FIG. 3 shows relationship between the mass ratio (%) of ethanol relative to diacetone alcohol and the ionomer coverage. As shown in FIG. 3, it was found that when the mass ratio of ethanol increased, the ionomer coverage also increased.

Moreover, as presented in Table 1, while the average thickness of the ionomer of Example 1 was about 8 nm, the thickness of Comparative Example 2 was about 5 nm. From these results, it was found that the ionomer of Example 1 covered the catalyst support with the lower coverage but the larger thickness.
2: Relationship Between Ionomer Coverage and Gas Diffusion Resistance

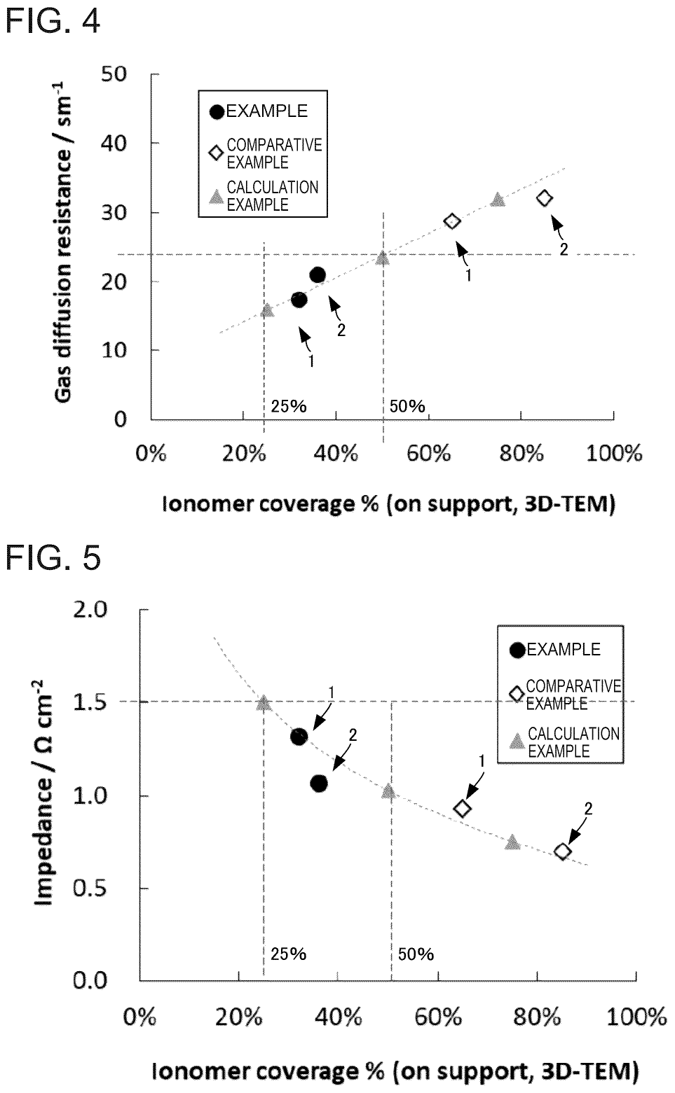

As shown FIG. 4, it was found that the ionomer coverage was preferably not more than 50% in order to satisfy the gas diffusion resistance being not more than 23.5 s/m as one target value. Notably, in FIG. 4, it was derived from the results of Examples 1 and 2 and Comparative Examples 1 and 2 based on a statistical technique that the gas diffusion resistance became not more than 23.5 s/m at the ionomer coverage not more than 50%.
3: Relationship Between Ionomer Coverage and Catalyst Layer Proton Resistance

As shown in FIG. 5, it was found that the ionomer coverage was preferably not less than 25% in order to satisfy the catalyst layer proton resistance being not more than 1.5 ΩQ/cm² as one target value. Notably, in FIG. 5, it was derived from the results of Examples 1 and 2 and Comparative Examples 1 and 2 based on a statistical technique that the catalyst layer proton resistance became not more than 1.5 ΩQ/cm² at the ionomer coverage not less than 25%.
4: Relationship Between Ionomer Coverage and Power Generation Characteristics

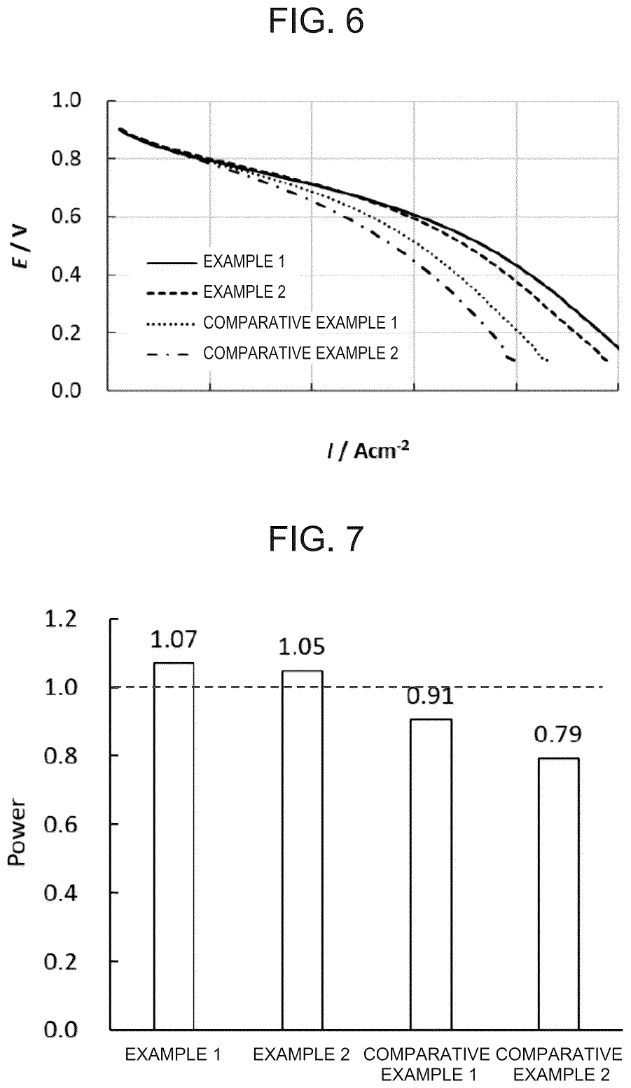

As shown in FIG. 6, it was found that Examples 1 and 2 afforded higher power generation performance than Comparative Examples 1 and 2. It is considered that this is because Examples 1 and 2 satisfy the gas resistance being not more than 23.5 s/m and the catalyst layer proton resistance being not more than 1.5 ΩQ/cm².
5: Relationship Between Ionomer Coverage and Power Generation Characteristics

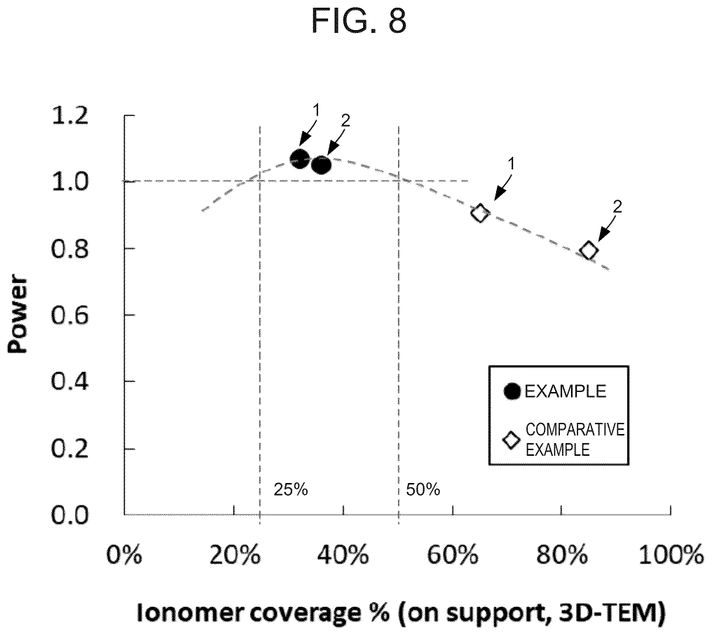

As shown in FIG. 7, it was found that Examples 1 and 2 afforded higher power generation performance than Comparative Examples 1 and 2. Notably, on the axis of ordinates, the output as the reference is indicated to be 1 accordingly. It is considered that the results are obtained because Examples 1 and 2 satisfy the gas resistance being not more than 23.5 s/m and the catalyst layer proton resistance being nor more than 1.5 ΩQ/cm². Moreover, as shown in FIG. 8, it was found that when the ionomer coverage was not less than 25% and not more than 50%, the output target value was able to be sufficiently secured.

It was found from the results above that by setting the ionomer coverage to be not less than 25% and not more than 50%, the gas diffusion resistance and the proton resistance were able to be made compatible with each other to obtain high power generation performance. Moreover, with reference to FIG. 3 again, from the results of Examples 1 and 2 and Comparative Examples 1 and 2, the mass ratio of ethanol corresponding to the ionomer coverage being not less than 25% and not more than 50% was not less than 0.10 and not more than 0.50. It was accordingly found that by using the aqueous medium having the mass ratio of ethanol relative to diacetone alcohol being not less than 0.10 and not more than 0.50 and the ionomer, the catalyst layer having the ionomer coverage being not less than 25% and not more than 50% was able to be obtained.

What is claimed is:

1. An electrode catalyst layer for a fuel cell, the electrode catalyst layer comprising:
a catalyst supporting material having
a catalyst support, and
a catalyst metal supported on the catalyst support; and
an ionomer partially covering the catalyst supporting material, wherein
an ionomer coverage is not less than 25% and not more than 50%, the ionomer coverage being a ratio of a surface area covered by the ionomer relative to a surface area of the catalyst support obtained by three-dimensional transmission electron microscopy.

2. The electrode catalyst layer according to claim 1, wherein an average thickness of the ionomer is not less than 6 nm and not more than 20 nm.

3. The electrode catalyst layer according to claim 1, wherein the ionomer includes a sulfonic acid-based ionomer.

4. The electrode catalyst layer according to claim 1, wherein the catalyst support is porous particles or solid particles.

5. A membrane electrode assembly for a fuel cell comprising the electrode catalyst layer according to claim 1.

6. A fuel cell comprising the membrane electrode assembly for a fuel cell according to claim 5.

7. A manufacturing method for an electrode catalyst layer for a fuel cell, the method comprising:
preparing a catalyst ink including
a catalyst supporting material having
a carbon-based catalyst support, and
a catalyst metal supported on the catalyst support,
an ionomer, and
an aqueous medium including
water,
a bipolar solvent having a boiling point exceeding 100° C. and not more than 170° C., and
ethanol; and
feeding the catalyst ink onto a base substrate and drying to form the electrode catalyst layer.

8. The manufacturing method according to claim 7, wherein the bipolar solvent includes diacetone alcohol.

9. The manufacturing method according to claim 7, wherein a mass ratio of the ethanol relative to the bipolar solvent is not less than 0.10 and not more than 0.50.

10. The manufacturing method according to claim 9, wherein the mass ratio of the ethanol relative to the bipolar solvent is not less than 0.13 and not more than 0.42.
